(19) United States
(12) Patent Application Publication
(10) Pub. No.: US 2021/0362978 A1
(43) Pub. Date: Nov. 25, 2021

(54) PASSENGER WAITING ASSESSMENT SYSTEM

(71) Applicant: Otis Elevator Company, Farmington, CT (US)

(72) Inventor: Paul Stranieri, Bristol, CT (US)

(21) Appl. No.: 16/879,179

(22) Filed: May 20, 2020

(51) Int. Cl. B66B 5/00; B66B 1/34; B66B 1/46; B66B 1/24

(52) U.S. Cl. CPC B66B 5/0012; B66B 1/3476; B66B 2201/215; B66B 1/2458; B66B 2201/211; B66B 1/468

(57) ABSTRACT

A passenger waiting assessment system including: a sensor; and a dispatcher including: a processor; and a memory including computer-executable instructions that, when executed by the processor, cause the processor to perform operations, the operations including: receiving a number of elevator calls; assigning the elevator calls to an elevator car of a first elevator system; moving the elevator car of the first elevator system to a landing; detecting, using the sensor, a number of individuals waiting to use the elevator car of the first elevator system; and stopping assignment of any further elevator calls to the elevator car of the first elevator system when the number of individuals is greater than a threshold value.

### BACKGROUND

The subject matter disclosed herein relates generally to the field of elevator systems, and specifically to a method and apparatus for detecting passengers for elevator cars.

Elevator calls may be submitted by a first passenger however nothing restricts a second passenger from piggy-backing by catching a ride on the elevator car called by the first passenger. Piggy-backing can cause a car to be overcrowded if the dispatcher is unaware of the extra passengers waiting for that car.

### BRIEF SUMMARY

According to an embodiment, a passenger waiting assessment system is provided. The passenger waiting assessment system including: a sensor; and a dispatcher including: a processor; and a memory including computer-executable instructions that, when executed by the processor, cause the processor to perform operations, the operations including: receiving a number of elevator calls; assigning the elevator calls to an elevator car of a first elevator system; moving the elevator car of the first elevator system to a landing; detecting, using the sensor, a number of individuals waiting to use the elevator car of the first elevator system; and stopping assignment of any further elevator calls to the elevator car of the first elevator system when the number of individuals is greater than a threshold value.

In addition to one or more of the features described herein, or as an alternative, further embodiments may include that the operations further include: determining a total area of individuals waiting to use the elevator car of the first elevator system; and stopping assignment of any further elevator calls to the elevator car of the first elevator system when the total area of individuals is greater than a selected floor area of the elevator car of the first elevator system.

In addition to one or more of the features described herein, or as an alternative, further embodiments may include that the operations further include: determining a total area of individuals and objects waiting to use the elevator car of the first elevator system; and stopping assignment of any further elevator calls to the elevator car of the first elevator system when the total area of individuals and objects is greater than a selected floor area of the elevator car of the first elevator system.

In addition to one or more of the features described herein, or as an alternative, further embodiments may include that the operations further include: determining a total volume of individuals waiting to use the elevator car of the first elevator system; and stopping assignment of any further elevator calls to the elevator car of the first elevator system when the total volume of individuals is greater than a selected volume of the elevator car of the first elevator system.

In addition to one or more of the features described herein, or as an alternative, further embodiments may include that the operations further include: determining a total volume of individuals and objects waiting to use the elevator car of the first elevator system; and stopping assignment of any further elevator calls to the elevator car of the first elevator system when the total volume of individuals and objects is greater than a selected volume of the elevator car of the first elevator system.

In addition to one or more of the features described herein, or as an alternative, further embodiments may include that the sensor is a radar sensing system.

In addition to one or more of the features described herein, or as an alternative, further embodiments may include that the sensor is a millimeter wave radar sensing system.

In addition to one or more of the features described herein, or as an alternative, further embodiments may include that the sensor is located above or adjacent an entryway of the first elevator system.

In addition to one or more of the features described herein, or as an alternative, further embodiments may include a sign for the first elevator system, wherein the sensor is located within the sign.

In addition to one or more of the features described herein, or as an alternative, further embodiments may include that the sign is located above or adjacent an entryway of the first elevator system.

In addition to one or more of the features described herein, or as an alternative, further embodiments may include that the sign is in electronic communication with the dispatcher of the first elevator system and the sensor is in communication with the dispatcher through the sign.

In addition to one or more of the features described herein, or as an alternative, further embodiments may include that individuals that are detected waiting to use the elevator car of the first elevator system are located within a waiting area located in front of an entryway of the first elevator system.

In addition to one or more of the features described herein, or as an alternative, further embodiments may include that the operations further include: reassigning the one or more of the elevator calls to an elevator car of a second elevator system; and moving the elevator car of the second elevator system to the landing.

In addition to one or more of the features described herein, or as an alternative, further embodiments may include that the threshold is adjustable based upon a user load on the first elevator system.

In addition to one or more of the features described herein, or as an alternative, further embodiments may include that the operations further include: re-assigning or cancelling one or more of the elevator calls when the number of individuals is greater than a threshold value of the elevator car of the first elevator system.

According to another embodiment, a method of operating one or more elevator systems is provided. The method including: receiving a number of elevator calls; assigning the elevator calls to an elevator car of a first elevator system; moving the elevator car of the first elevator system to a landing; detecting, using a sensor, a number of individuals waiting to use the elevator car of the first elevator system; and stopping assignment of any further elevator calls to the elevator car of the first elevator system when the number of individuals is greater than a threshold value of the elevator car of the first elevator system.

In addition to one or more of the features described herein, or as an alternative, further embodiments may include: determining a total area of individuals waiting to use the elevator car of the first elevator system; and stopping assignment of any further elevator calls to the elevator car of the first elevator system when the total area of individuals is greater than a selected floor area of the elevator car of the first elevator system.

In addition to one or more of the features described herein, or as an alternative, further embodiments may include: determining a total area of individuals and objects waiting to use the elevator car of the first elevator system; and stopping assignment of any further elevator calls to the elevator car of the first elevator system when the total area of individuals and objects is greater than a selected floor area of the elevator car of the first elevator system.

In addition to one or more of the features described herein, or as an alternative, further embodiments may include: determining a total volume of individuals waiting to use the elevator car of the first elevator system; and stopping assignment of any further elevator calls to the elevator car of the first elevator system when the total volume of individuals is greater than a selected volume of the elevator car of the first elevator system.

According to another embodiment, a computer program product embodied on a non-transitory computer readable medium is provided. The computer program product including instructions that, when executed by a processor, cause the processor to perform operations including: receiving a number of elevator calls; assigning the elevator calls to an elevator car of a first elevator system; moving the elevator car of the first elevator system to a landing; detecting, using a sensor, a number of individuals waiting to use the elevator car of the first elevator system; and stopping assignment of any further elevator calls to the elevator car of the first elevator system when the number of individuals is greater than a threshold value of the elevator car of the first elevator system.

Technical effects of embodiments of the present disclosure include using detected passengers waiting for an elevator car to help find individuals piggy-backing on elevator calls made by other individuals.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates a schematic view of a passenger waiting assessment system, in accordance with an embodiment of the disclosure;

FIG. 3 illustrates a schematic view of sensor within a sign for the passenger waiting assessment system of FIG. 2, in accordance with an embodiment of the disclosure; and

FIG. 4 is a flow chart of method of operating one or more elevator systems, in accordance with an embodiment of the disclosure.

### DETAILED DESCRIPTION

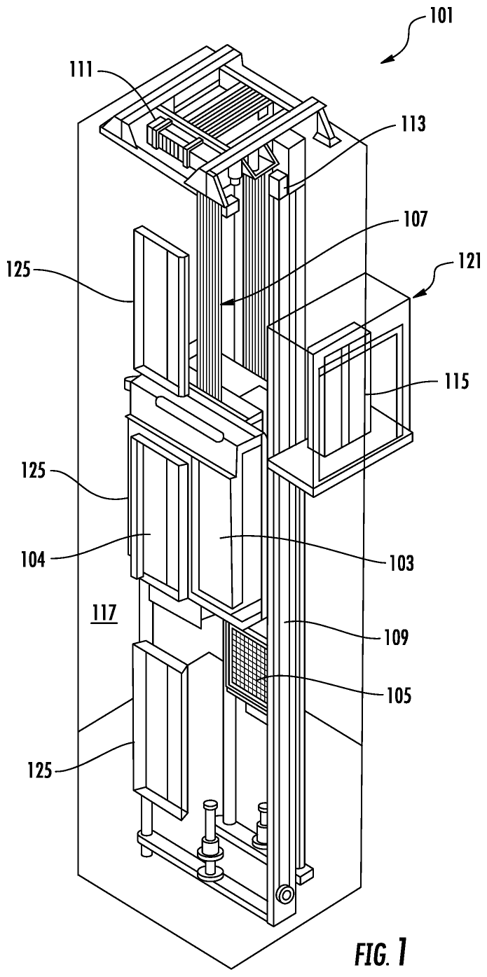

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

In other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1. In one example, embodiments disclosed herein may be applicable conveyance systems such as an elevator system 101 and a conveyance apparatus of the conveyance system such as an elevator car 103 of the elevator system 101. In another example, embodiments disclosed herein may be applicable conveyance systems such as an escalator system and a conveyance apparatus of the conveyance system such as a moving stair of the escalator system.

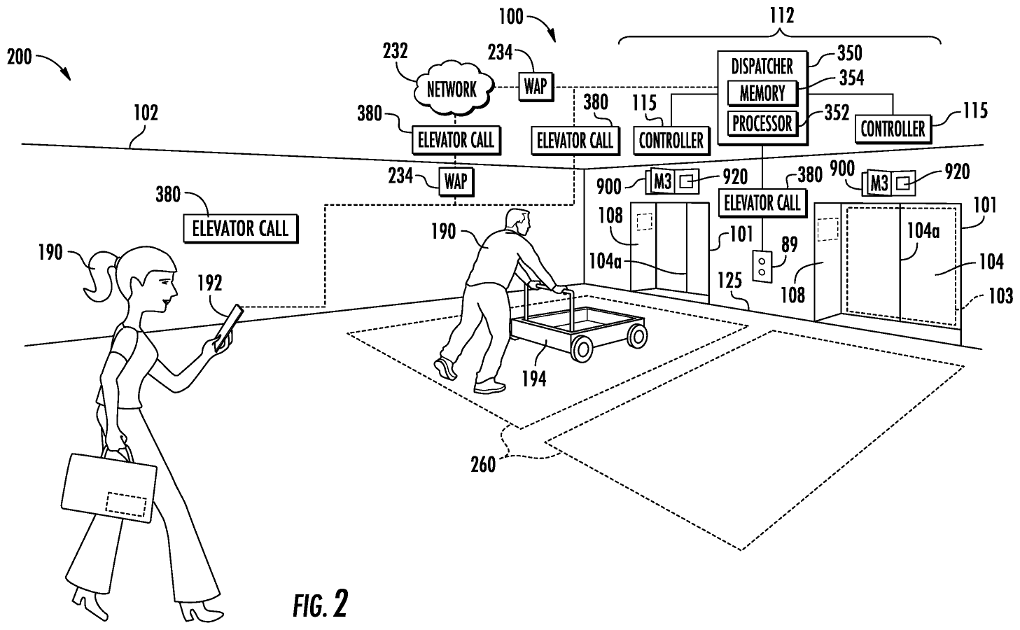

The elevator system 101 also includes one or more elevator doors 104. The elevator door 104 may be integrally attached to the elevator car 103. There may also be an elevator door 104 located on a landing 125 of the elevator system 101 (see FIG. 2). Embodiments disclosed herein may be applicable to both an elevator door 104 integrally attached to the elevator car 103 and/or a landing elevator door 104a located on a landing 125 of the elevator system 101. The elevator doors 104, 104a opens to allow passengers to enter and exit the elevator car 103.

Referring now to FIG. 2, with continued reference to FIG. 1, a passenger waiting assessment system 200 is illustrated, in accordance with an embodiment of the present disclosure. It should be appreciated that, although particular systems are separately defined in the schematic block diagrams, each or any of the systems may be otherwise combined or separated via hardware and/or software.

As illustrated in FIG. 2, a building elevator system 100 within a building 102 may include multiple different individual elevator systems 101 organized in an elevator bank 112. The elevator systems 101 each include an elevator car 103 (one elevator car 103 is not shown in FIG. 2 for simplicity). It is understood that while two elevator systems 101 are utilized for exemplary illustration, embodiments disclosed herein may be applied to building elevator systems 100 having one or more elevator systems 101. Further, the elevator systems 101 illustrated in FIG. 2 are organized into an elevator bank 112 for ease of explanation but it is understood that the elevator systems 101 may be organized into one or more elevator banks 112. Each of the elevator banks 112 may contain one or more elevator systems 101. Each of the elevator banks 112 may also be located on the same or different landings 125.

There may be an elevator call device 89 located proximate the elevator systems 101 on the landing 125. The elevator call device 89 transmits an elevator call 380 to a dispatcher 350 of the building elevator system 100. The elevator call 380 may include a destination for the individual 190 (i.e., passenger). It should be appreciated that, although the dispatcher 350 is separately defined in the schematic block diagrams, the dispatcher 350 may be combined via hardware and/or software in any controller 115 or other device. The elevator call 380 may include the source (i.e., the individual 190 who made the elevator call 380) of the elevator call 380. The elevator call device 89 may include a destination entry option that includes the destination of the elevator call 380. The elevator call device 89 may be a push button and/or a touch screen and may be activated manually or automatically. For example, the elevator call 380 may be sent by an individual 190 via the elevator call device 89.

A mobile device 192 may also be configured to transmit an elevator call 380. The individual 190 may be in possession of the mobile device 192 to transmit the elevator call 380. The mobile device 192 may be a smart phone, smart watch, laptop, or any other mobile device known to one of skill in the art. The mobile device 192 may be configured to transmit the elevator call 380 through computing network 232 to the dispatcher 350 or directly to the dispatcher 350. The mobile device 192 may communicate to the computing network 232 through a wireless access protocol device (WAP) 234 using short-range wireless protocols. Short-range wireless protocol may include, but are not limited to, Bluetooth, BLE, Wi-Fi, HaLow (801.11ah), zWave, ZigBee, or Wireless M-Bus. Alternatively, the mobile device 192 may communicate directly with the computing network 232 or the dispatcher 350 using long-range wireless protocols. Long-range wireless protocols may include, but are not limited to, cellular, LTE (NB-IoT, CAT M1), LoRa, satellite, Ingenu, or SigFox.

The controllers 115 can be combined, local, remote, cloud, etc. The dispatcher 350 may be local, remote, cloud, etc. The dispatcher 350 is in communication with the controller 115 of each elevator system 101. Alternatively, there may be a single controller that is common to all of the elevator systems 101 and controls all of the elevator system 101, rather than two separate controllers 115, as illustrated in FIG. 2. The dispatcher 350 may be a ‘group’ software that is configured to select the best elevator car 103 to be assigned to the elevator call 380. The dispatcher 350 manages the elevator call devices 89 related to the elevator bank 112.

The dispatcher 350 is configured to control and coordinate operation of multiple elevator systems 101. The dispatcher 350 may be an electronic controller including a processor 352 and an associated memory 354 comprising computer-executable instructions that, when executed by the processor 352, cause the processor 352 to perform various operations. The processor 352 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 354 may be but is not limited to a random access memory (RAM), read only memory (ROM), or other electronic, optical, magnetic or any other computer readable medium.

The dispatcher 350 is in communication with the elevator call devices 89 of the building elevator system 100. The dispatcher 350 is configured to receive the elevator call 380 transmitted from the elevator call device 89 and/or the mobile device 192. The dispatcher 350 is configured to manage the elevators calls 380 coming in from the elevator call device 89, and/or mobile devices 192 then command one or more elevator systems 101 to respond to elevator call 380.

The passenger waiting assessment system 200 also includes a sensor 920 configured to detect individuals 190 and/or objects 194 waiting for an elevator car 103. The individuals 190 may be standing in waiting areas 260 located in front of an entryway 108 to a landing elevator door 104a located on the landing 125. The sensor 920 is configured to determine individuals located in this waiting area 260. The sensor may visualize the waiting area 260 within its total viewing area. In an embodiment, the sensor 920 may be located above or adjacent the entryway 108 and the landing elevator door 104 to obtain a good view of the waiting area 260 for the elevator system 101. In an embodiment, there is one sensor 920 per elevator system 101. In another embodiment, there may be one sensor 920 per elevator bank 112. In an embodiment, the sensor 920 is located in an elevator sign 900, as illustrated in FIG. 2. The sign 900 may be located above or adjacent the entryway 108 and the landing elevator door 104 to obtain a good view of the waiting area 260 for the elevator system 101. The elevator sign 900 may identify the present landing 125 where the elevator car 103 of the elevator system 101 is currently located so that an individual 190 waiting for the elevator car 103 may know when the elevator car 103 will arrive. Advantageously, the sensor 920 may be configured to be discreetly hidden within the sign 900, such that the sensor 920 is not visible by individuals 190 on the landing 125.

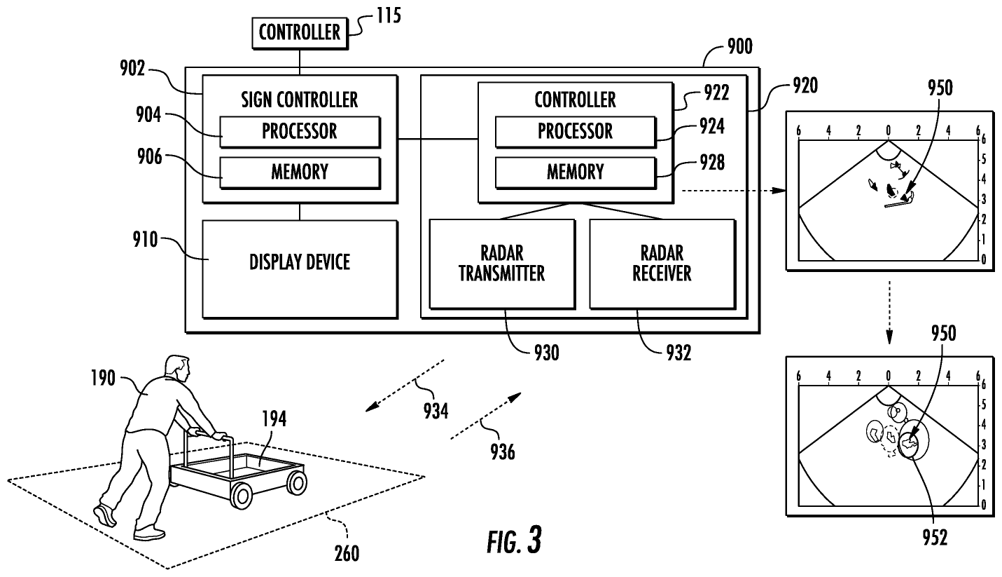

Referring now to FIG. 3, with continued reference to FIGS. 1-2, a schematic view of the sign 900 is illustrated, in accordance with an embodiment of the present disclosure. The sign 900 is in communication with the controller 115 of the elevator system 101. As illustrated in FIG. 3, the sensor 920 may be located inside of the sign 900. For example, the sensor 920 be composed entirely on a circuit board that is installed in an open connector on the sign 900.

The sign 900 includes a sign controller 902 configured to control operation of the sign 900. The sign controller 902 may be an electronic controller including a processor 904 and an associated memory 906 comprising computer-executable instructions that, when executed by the processor 904, cause the processor 904 to perform various operations. The processor 904 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 906 may be but is not limited to a random access memory (RAM), read only memory (ROM), or other electronic, optical, magnetic or any other computer readable medium. In one embodiment, there may be no sign controller 902 and the inputs may come from the controller 115 of the elevator system 101 or elsewhere.

The sign 900 also includes a display device 910 configured to display a landing 125 where the elevator car 103 of the elevator system 101 is currently located. It is understood that the display device 910 is not limited to displaying the landing 125 and the embodiments disclosed herein are applicable with display devices 910 displaying other information. The display can be a traditional screen-type display (e.g., computer monitor ore television), a fixed segment display, or a light up fixed display of elevator number, floor, bank, etc.

The sensor 920 includes a controller 922 configured to control operation of the sensor 920. The controller 920 is in communication with sign controller 902. The controller 922 may be an electronic controller including a processor 924 and an associated memory 928 comprising computer-executable instructions that, when executed by the processor 924, cause the processor 924 to perform various operations. The processor 924 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 928 may be but is not limited to a random access memory (RAM), read only memory (ROM), or other electronic, optical, magnetic or any other computer readable medium.

In an embodiment, the sensor 920 is a radar sensing system as illustrated in FIG. 3. In an embodiment, the sensor 920 is a millimeter wave radar sensing system. The sensor 920 includes a radar transmitter 930 and a radar receiver 932. The radar transmitter 930 is configured to emit a radar pulse 934 and the radar receiver is configured to detect a reflected radar pulse 936. The reflected radar pulse 936 is the radar pulse 934 that is reflected off of individuals 190 and objects 194. Advantageously, the radar pulse 934 can transfer through the outer covering/structure of the sign 900 and thus the sensor 920 may be hidden inside the sign 900 away from view of individuals 190. It is advantageous to utilize radar because no apertures are required in the outer covering/structure of the sign 900. It is also advantageous to utilize radar over video or images for privacy concerns, as no actual image of the individual 190 is collected.

The reflected radar pulse 936 is detected by the radar receiver 932 and analyzed by the radar controller 922. The reflected radar pulse 936 that is reflected off an individual 190 or an object 194 is received and analyzed as a point cloud 950. The point cloud 950 may be two-dimensional and/or three-dimensional point cloud. The radar controller 922 is configured to determine whether each point cloud 950 is an individual 190 or an object 194. Once an individual 190 or an object 194 is identified in the point cloud 950. The radar controller 922 may be configured to only focus on point clouds 950 within the waiting area 260 of an elevator system 101. The point clouds 950 may be circled 952 by the controller 922 to identify them as a point individual 190 or object 194. The radar controller 922 may be configured to determine an approximate size of each of the individual 190 or object 194. The size may be defined as the volume and/or the floor space that an individual 190 or object 194 occupies. Advantageously, by being able to determine the volume and/or floor space occupied by the individuals 190 and/or the objects 194 waiting for an elevator car 103, this information may be shared with the controller 115 and/or the dispatcher 350 to determine whether the arriving elevator car 103 will have enough space to accommodate the individual 190 and/or objects 194 within the elevator car 103. If the elevator car 103 does not have enough space to accommodate the individuals 190 and/or objects 194 some the elevator calls 380 may be re-assigned to different elevator cars 103. The dispatcher 350 is configured to assign elevator calls 380 as they are received. One elevator call 380 may be equivalent to one individual and the dispatcher 350 may be configured to book the elevator car 130 to a selected fullness percentage.

Advantageously, by comparing a number of individuals 190 waiting for an elevator car 103 to a number of elevator calls 380, the dispatcher 350 can then determine whether one individual 190 is “piggy-backing” on an elevator call 380 of another individual 190.

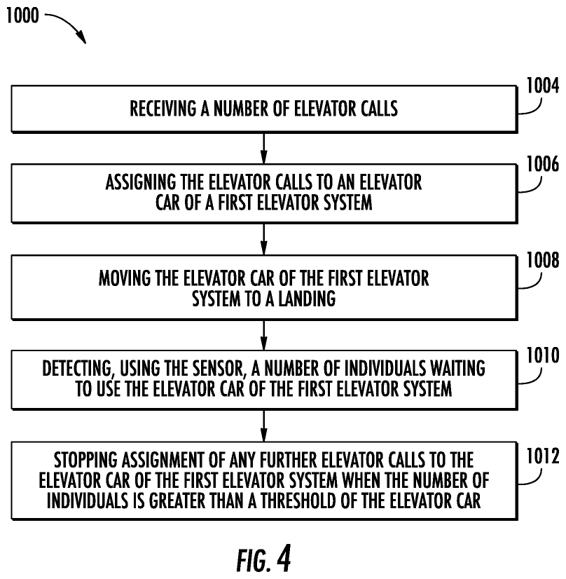

Referring now to FIG. 4, with continued reference to FIGS. 1-2, a flow chart of method 1000 of operating one or more elevator systems 101 is illustrated, in accordance with an embodiment of the disclosure. In an embodiment, the method 400 is performed by the passenger waiting assessment system 200 or the dispatcher 350 of FIG. 2.

At block 1004, a number (e.g., measured quantity) of elevator calls 380 are received. At block 1006, the elevator calls 380 are assigned to an elevator car 103 of a first elevator system 101. The number of elevator calls 380 assigned to each elevator car 130 is tracked. At block 1008, the elevator car 103 of the first elevator system 101 is moved to a landing 125. At block 1010, a number of individuals 190 waiting to use the elevator car 103 of the first elevator system 101 is detected using a sensor 920. The individuals 190 waiting to use the elevator car 103 of the first elevator system 101 are located within a waiting area 260 located in front of an entryway 108 of the first elevator system 101.

At block 1012, the dispatcher 350 may stop assignment of any further elevator calls 280 to the elevator car 103 of the first elevator system 101 when the number of individuals 190 is greater than a threshold value of the elevator car 103 of the first elevator system 101. The threshold value may be less than or equal to a capacity of the elevator car 103. For example, the threshold value may be 90% capacity of the elevator car 103. It is understood, that the threshold value may be greater than or less than 90% capacity of the elevator car 103. In one embodiment, threshold is adjustable based upon a user load on the elevator system 101. For example, the threshold value may be higher during busy times or lower threshold during slow times. Additionally, one or more of the elevator calls 380 may be re-assigned or cancelled when the number of individuals 190 is greater than a threshold value of the elevator car 103 of the first elevator system 101.

The method 1000 may further comprise that a total area of individuals 190 waiting to use the elevator car 103 of the first elevator system 101 is determined. The dispatcher 350 may stop assignment of any further elevator calls 280 to the elevator car 103 of the first elevator system 101 when the total area of individuals 190 is greater than a selected floor area of the elevator car 103 of the first elevator system 101. The total area of individuals 190 is defined as the sum of the floor area that each individual 190 occupies. In one example, the selected floor area may be 90% of the floor area but it is understood that the selected floor area may be greater than or less than 90%.

The method 1000 may further comprise that a total area of individuals 190 and objects 194 waiting to use the elevator car 103 of the first elevator system 101 is determined. The dispatcher 350 may stop assignment of any further elevator calls 280 to the elevator car 103 of the first elevator system 101 when the total area of individuals 190 and objects 194 is greater than a selected floor area of the elevator car 103 of the first elevator system 101. The total area of objects 194 is defined as the sum of the floor area that each object 194 occupies.

The method 1000 may further comprise that a total volume of individuals 190 waiting to use the elevator car 103 of the first elevator system 101 is determined. The dispatcher 350 may stop assignment of any further elevator calls 280 to the elevator car 103 of the first elevator system 101 when the total volume of individuals 190 is greater than a selected volume of the elevator car 103 of the first elevator system 101. The total volume of individuals 190 is defined as the sum of the total volume that each individual 190 occupies. In one example, the selected volume may be 90% of the volume of the elevator car 103 but it is understood that the selected volume may be greater than or less than 90%.

The method 1000 may further comprise that a total volume of individuals 190 and objects 194 waiting to use the elevator car 103 of the first elevator system 101 is determined. The dispatcher 350 may stop assignment of any further elevator calls 280 to the elevator car 103 of the first elevator system 101 when the total volume of individuals 190 and objects 194 is greater than a selected volume of the elevator car 103 of the first elevator system 101. The total volume of objects 194 is defined as the sum of the total volume that each object 194 occupies.

In an embodiment, the sensor 920 is a radar sensing system. In another embodiment, the sensor 920 is a millimeter wave radar sensing system. In an embodiment, the sensor 920 is located above or adjacent an entryway 108 of the first elevator system 101. In an embodiment, the sensor 920 is located within a sign 900 of the first elevator system 101. In another embodiment, the sign 900 is located above or adjacent an entryway 108 of the first elevator system 101. The sign 900 is in electronic communication with the dispatcher 350 of the first elevator system 101 and the sensor 920 is in communication with the dispatcher 350 through the sign 900.

The method 1000 may further comprise that one or more of the elevator calls 380 are reassigned to an elevator car 103 of the second elevator system 101 and the elevator car 103 of the second elevator system 101 to the landing 125.

While the above description has described the flow process of FIG. 4 in a particular order, it should be appreciated that unless otherwise specifically required in the attached claims that the ordering of the steps may be varied.

The present invention may be a system, a method, and/or a computer program product at any possible technical detail level of integration. The computer program product may include a computer readable storage medium (or media) having computer readable program instructions thereon for causing a processor to carry out aspects of the present invention.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A passenger waiting assessment system comprising:
a sensor; and
a dispatcher comprising:
a processor; and
a memory comprising computer-executable instructions that, when executed by the processor, cause the processor to perform operations, the operations comprising:
receiving a number of elevator calls;
assigning the elevator calls to an elevator car of a first elevator system;
moving the elevator car of the first elevator system to a landing;
detecting, using the sensor, a number of individuals waiting to use the elevator car of the first elevator system; and
stopping assignment of any further elevator calls to the elevator car of the first elevator system when the number of individuals is greater than a threshold value.

2. The passenger waiting assessment system of claim 1, wherein the operations further comprise:
determining a total area of individuals waiting to use the elevator car of the first elevator system; and
stopping assignment of any further elevator calls to the elevator car of the first elevator system when the total area of individuals is greater than a selected floor area of the elevator car of the first elevator system.

3. The passenger waiting assessment system of claim 1, wherein the operations further comprise:
determining a total area of individuals and objects waiting to use the elevator car of the first elevator system; and
stopping assignment of any further elevator calls to the elevator car of the first elevator system when the total area of individuals and objects is greater than a selected floor area of the elevator car of the first elevator system.

4. The passenger waiting assessment system of claim 1, wherein the operations further comprise:
determining a total volume of individuals waiting to use the elevator car of the first elevator system; and
stopping assignment of any further elevator calls to the elevator car of the first elevator system when the total volume of individuals is greater than a selected volume of the elevator car of the first elevator system.

5. The passenger waiting assessment system of claim 1, wherein the operations further comprise:
determining a total volume of individuals and objects waiting to use the elevator car of the first elevator system; and
stopping assignment of any further elevator calls to the elevator car of the first elevator system when the total volume of individuals and objects is greater than a selected volume of the elevator car of the first elevator system.

6. The passenger waiting assessment system of claim 1, wherein the sensor is a radar sensing system.

7. The passenger waiting assessment system of claim 1, wherein the sensor is a millimeter wave radar sensing system.

8. The passenger waiting assessment system of claim 1, wherein the sensor is located above or adjacent an entryway of the first elevator system.

9. The passenger waiting assessment system of claim 1, further comprising:
a sign for the first elevator system, wherein the sensor is located within the sign.

10. The passenger waiting assessment system of claim 9, wherein the sign is located above or adjacent an entryway of the first elevator system.

11. The passenger waiting assessment system of claim 9, wherein the sign is in electronic communication with the dispatcher of the first elevator system and the sensor is in communication with the dispatcher through the sign.

12. The passenger waiting assessment system of claim 1, wherein individuals that are detected waiting to use the elevator car of the first elevator system are located within a waiting area located in front of an entryway of the first elevator system.

13. The passenger waiting assessment system of claim 1, wherein the operations further comprise:
reassigning the one or more of the elevator calls to an elevator car of a second elevator system; and
moving the elevator car of the second elevator system to the landing.

14. The passenger waiting assessment system of claim 1, wherein the threshold is adjustable based upon a user load on the first elevator system.

15. The passenger waiting assessment system of claim 1, wherein the operations further comprise:
re-assigning or cancelling one or more of the elevator calls when the number of individuals is greater than a threshold value of the elevator car of the first elevator system.

16. A method of operating one or more elevator systems, the method comprising:
receiving a number of elevator calls;
assigning the elevator calls to an elevator car of a first elevator system;
moving the elevator car of the first elevator system to a landing;
detecting, using a sensor, a number of individuals waiting to use the elevator car of the first elevator system; and
stopping assignment of any further elevator calls to the elevator car of the first elevator system when the number of individuals is greater than a threshold value of the elevator car of the first elevator system.

17. The method of claim 16, further comprising:
determining a total area of individuals waiting to use the elevator car of the first elevator system; and
stopping assignment of any further elevator calls to the elevator car of the first elevator system when the total area of individuals is greater than a selected floor area of the elevator car of the first elevator system.

18. The method of claim 16, further comprising:
determining a total area of individuals and objects waiting to use the elevator car of the first elevator system; and
stopping assignment of any further elevator calls to the elevator car of the first elevator system when the total area of individuals and objects is greater than a selected floor area of the elevator car of the first elevator system.

19. The method of claim 16, further comprising:
determining a total volume of individuals waiting to use the elevator car of the first elevator system; and
stopping assignment of any further elevator calls to the elevator car of the first elevator system when the total volume of individuals is greater than a selected volume of the elevator car of the first elevator system.

20. A computer program product embodied on a non-transitory computer readable medium, the computer program product including instructions that, when executed by a processor, cause the processor to perform operations comprising:
receiving a number of elevator calls;
assigning the elevator calls to an elevator car of a first elevator system;
moving the elevator car of the first elevator system to a landing;
detecting, using a sensor, a number of individuals waiting to use the elevator car of the first elevator system; and
stopping assignment of any further elevator calls to the elevator car of the first elevator system when the number of individuals is greater than a threshold value of the elevator car of the first elevator system.
